(19) United States
(12) Patent Application Publication
(10) Pub. No.: US 2006/0201063 A1
(43) Pub. Date: Sep. 14, 2006

(54) Plant delivery apparatus and method

(76) Inventor: Graeme John Huon, Victoria (AU)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/363,253

(22) Filed: Feb. 28, 2006

(30) Foreign Application Priority Data
Mar. 1, 2005 (AU) 2005900946

(51) Int. Cl. A01G 25/00

(52) U.S. Cl. 47/81

(57) ABSTRACT

Apparatus and method are disclosed for sustained delivery of a wide range of plant supplemental and treatment materials. The treatment materials are delivered to the plant in a non-aqueous gaseous phase.

### REFERENCE TO RELATED APPLICATIONS

This application claims the benefit of priority under Australian Provisional Application Provisional Claim No. 2005900946 filed Mar. 1, 2005, Melbourne Australia entitled Plant Delivery Apparatus and Method.

### FIELD OF THE INVENTION

The present invention relates to apparatus and method suitable for delivery of plant supplemental and treatment materials over extended periods of time.

### BACKGROUND OF THE INVENTION

All manner of plants are subject to growth influencing factors including macro and micro-mineral, trace element and enzyme, vitamin and other needs and deficiencies, impact and damage from numerous viral, fungal and bacterial diseases, insects and other boring and grazing pests. Such attacks can be localised or systemic. Pests can separately attack and be harboured in the roots, trunk, branches, leaves, fruit, flower and non-active sap portions of the plant and at various stages in their lifecycle. Some pests reside in the soil in proximity to the root structure.

The effect of such growth influencing factors (including pests) on the plant is to interfere with the growth processes, damage and destroy growth structure and in some cases to destroy the plant beyond repair. This has economic, environmental and aesthetic consequences.

Treatments for these factors include fumigation, surface root treatment, spraying, dusting, drenching and direct injection of nutrients, growth affecting materials, pesticides, bacterial control agents and fungicides. Such treatment methods run the risk of damage to the plant and, due to the need to ensure adequate delivery and effectiveness of the active compounds in the target plants, inevitably introduce high chemical concentrations onto and into the plant, the local environment and the soil.

Alternately some plants are unwanted or in the wrong place also known as weeds and it is thus desired to destroy or otherwise treat them. Present alternatives include manual removal and chemical herbicide application. Chemical treatment in proximity to plants that are desired to be kept presents difficulties as it is possible that inaccurate or indiscriminate application of herbicide chemicals may damage these plants.

In the cases of growth treatments and weed control, the delivery apparatus is often difficult and dangerous to use requiring extensive training and the use of a wide range of protective equipment. Hazardous chemical mixtures are used and these are often packed in concentrated forms for ease of shipping for the necessary large dosages. The handling of these concentrated forms presents a further spillage and contamination risk to the environment and to the workers' health and safety. In most cases the quantity of chemical applied is far greater than the end concentration achieved in the target plant and there is much wastage and consequent potential pollution or chemical trespass.

Furthermore, some combinations of chemicals can also have undesirable and unpredictable deleterious effects and pose cross-contamination risks to neighbouring agricultural processes.

The application of these treatments is labour intensive and must usually be done to a strict timetable relating to plant type, season, weather and habits of the target pests. This timetable ideally varies with each plant type, target pest and chemical mixture type, making an extended variable and repeated treatment schedule necessary.

Any attempt to reduce or shorten the treatment cycle would result in reduced effectiveness or the need for additional chemicals or both and increased risk to the plants, the environment and the workers.

Furthermore, the application effectiveness is subject to significant influence by for example the weather and temperature on the day, and it is difficult to gauge whether a particular plant has received appropriate treatment or indeed any treatment by inspection after the event. These factors are rarely if ever convenient to the plant carer.

In some cases the sheer size of the plant means that treatment is difficult, particularly at the plant extremes such as tree canopies where most new growth is occurring, and within or adjacent to the root structures where there is substantial soil coverage.

Treatment access can be difficult or impossible such as with systemic virus, bacteria, fungus, sub-dermal and subterranean pests and heartwood borers.

The inability to accurately control the intentional and unintentional delivery factors also means that some treatment regimes cannot be used. This is particularly true where both wild and domestic animals are present and their control cannot be guaranteed, and also where helpful casual grazers such as bees must be given some degree of protection.

Access to plants can be quite difficult at the times treatments have to be done. For example spring rain can make vehicular access difficult, dusting and spraying cannot be done in high wind or extremely hot weather and rain washes off topical treatments.

The limitations of foliar and root delivery mechanisms are well known including difficulty of access and delivery control, damage to the plant by excess concentration burn and inability to control environmental factors such as sun, wind and rain. It would be desirable to deliver materials directly to the plant by other means to overcome the difficulties of accessing the foliar canopy and roots underground. Attempts at this have used aqueous based treatment regimes and directly applied these to other areas of the plant such as directly to the dermis. This has not been effective to date in a large part because known aqueous enabled delivery mechanisms cause secondary reactions by the plant at the site of application including change in the nature of the exposed dermis by the plant in response to the moisture presented, harbouring and growth of bacteria, fungus and virus agents in the presented moisture and attraction of insects responding to moisture, treatment and sap materials present, particularly when extended treatment durations are used.

These factors have meant that long term delivery of materials by this means was not possible, and effort has thus concentrated on short term treatment localised to the application site and rapid take-up.

Prior art has extensively used traditional foliar and root feeding mechanisms to deliver a wide variety of growth influencing and well-being substances to plants. These mechanisms have the advantage of being well established but have disadvantages including slow take-up, ineffective delivery, limited range of suitable substances, limited range of possible concentrations to avoid damage to the plant, the need for multiple treatments in order to maintain effectiveness, difficulty and costliness of application particularly with foliar application on large plants as is required and unintentional substance trespass.

Prior art methods have delivered substances to plants in many forms such as aqueous base or dust or powder. Many apparatus for foliar and root delivery through soil application have also been developed. These treatment methods and apparatus have been and continue to be developed and patented in the art.

More recently, new techniques to improve the rate of substance delivery to plants have been developed and alternate access paths to the plant including direct injection and trans-cuticular methods have begun to appear. Some of these methods and apparatus extend from or are based on agents used to improve take-up rate of existing foliar and root treatments or target a specific chemical for delivery but still involve an aqueous delivery regime.

Tojo et al. (U.S. Pat. No. 5,866,141, 1996) described a pesticide patch preparation comprising a mixed layer of the anti-cholinesterase insecticide imidacloprid, adhesive and at least one of a surface active agent solvent or adhesive as said components. This was then dispersed or painted on a flexible substrate made of a specified set of plastics materials. and applied to a particular target treatment site on a plant. The invention and published work also found that the rate of delivery of the specified bioactive material could be increased by the use of specific chemicals being p-menthane derivatives l-menthol and d-limonene.

Manankov (U.S. Pat. No. 4,291,497, 1981) recognised the ability of alcohols and water soluble low molecular weight carbohydrates (including those found in some growing plant species) to augment the uptake of applied powders and previously used aqueous solutions. The method and apparatus described was intended to accelerate the uptake of traditionally applied materials. Manankov also extended the potential bioactive or bio-influencing materials to include macro-elements, trace elements, vitamins, phytohormones, plant growth inhibitors, agents for plant disease control, agents for plant pest control and mixtures thereof The Maninkov patent does not deal with reactions the plant structure would have to extended aqueous, carbohydrate or alcohol/aqueous presence at the point of application and does not comment on any secondary effects this may have of attracting grazing insects and animals. As such the treatment is not ideally suited for extended duration. The method proposed by Manankov also relies on aqueous compatibility including hygroscopic or alcohol soluble substances.

Itzel (U.S. Pat. No. 5,201,925, 1994) discloses systemic delivery using a self-adhesive apparatus which is permeable to the intended delivery substance. This apparatus is intended to provide effective delivery of a range of active substances. However, no allowance is made for the growth resulting in change in girth of the plant and the related epidermal changes including expansion, cell regeneration and replacement or bark shedding occurring on a season by season basis for example.

Rolf (U.S. Pat. No. 5,142,817, 1992) describes an adhesive based wrap that relies on atmospheric moisture for activation.

What is needed is a general delivery and treatment regime that overcomes or ameliorates some or all of these limitations. The reference to any prior art in this specification is not, and should not be taken as an acknowledgement or any form of suggestion that the prior art forms part of the common general knowledge.

### SUMMARY OF INVENTION

The invention discloses an apparatus and method for treatment of plants which, in various embodiments has one or more of the following advantages:
cost effectiveness;
fast and simple to apply;
can be applied at a time convenient to the carer;
minimises or eliminates field mixing of chemicals and risk of spillage, chemical trespass or carer contamination;
targets the or each particular pest or treatment;
efficiently uses treatment substances;
enables extended time treatment of the plant even spanning one or more growing seasons;
ensures minimal damage to the plant occurs due to the treatment during this extended time; avoiding influence of uncontrolled virus, bacteria, fungi or other substances.
enables targeted delivery of materials or substances to particular plants, and within a plant systemically and to specific plant areas including roots, trunk, stem, branch, seed, flower and fruit including the deep root structures and surrounding deep soil and the tips of tall trees;
shows evidence of the nature of treatment, time the applications with seasons and application time as required for maximum effectiveness;
allows scaling of dosage at the point of need with growth rates, temperatures, transpiration etc;
operates at or near atmospheric pressure,
enables new treatment regimes and applications (eg. delivery of agents normally susceptible to degradation by air or soil contact or ultraviolet light, grazing insect repellents, pollination and fruit growth control agents during treatment of other targeted pests, delivery of growth control factors for example for selective pruning, provision of colour, odour and flavour substitutes and enhancers and marsupial and other grazing pest discouragers; and
enables improved research, monitoring and testing of plants.

The invention in a first aspect provides an apparatus for delivering one or more materials to a plant including a source element that comprises a material that provides a non-aqueous gaseous phase to be delivered to a plant, and a reservoir in fluid flow communication with said source element, the reservoir providing non-aqueous gaseous phase flow of the one or more materials from the reservoir to the plant.

The material present in the source element can be a liquid, a solid, or a gas. The material should provide a gas phase at or near atmospheric pressure. The material can also for example be a solid or liquid dispersed in a solid matrix. Preferably, the solid matrix provides pores or interstices for fluid to travel from the interior of the material. The source element also desirably includes a support structure that helps retain the position of the source element in the apparatus, and may aid in transportation and handling of the material.

Preferably, the apparatus provides control means for controlling the flow of said one or more materials to the plant, and the control means controls flow of the gas phase from said source element to said reservoir.

Preferably the source element is spaced from and not in physical contact with the plant.

Preferably, the reservoir is in fluid flow communication with the exterior of the plant and the material is delivered transdermally to the plant.

Preferably, attachment means are provided for attaching the apparatus to the plant, and the reservoir surrounds at least half of the circumference of the plant at the location of attachment of the apparatus on the plant.

Preferably, the source element includes an active agent that has a beneficial effect on the living plant or influences plant properties after harvest. Suitable active agents include one or more of plant growth control and augmentation agents, vitamins, hormones, pheromones, attractants, repellants, trace and macro elements and minerals, fungus, virus, bacteria, antibiotics, anti-viral agents, colour, odour enhancers or modifiers, taste enhancers or modifiers, and other desired agents that effect treatments that influence plant properties such as colour, smell, rot, fungus and grazing pest resistance after harvest.

For some materials, it is desirable that the source element includes a trans-dermal delivery facilitation material.

The apparatus can include removable barrier means for preventing flow of gas phase material to the plant until the start of the desired plant treatment period.

The reservoir can be provided with peripheral walls that surround an exit opening, the pheral walls possessing surface conformal properties to enable a relatively impermeable seal to form between the reservoir wall and the plant exterior.

Desirably, the reservoir contains material at or near local atmospheric pressure and delivers to the plant material at or near local atmospheric pressure.

Preferably, the reservoir includes a wall structure that is substantially gas phase impermeable, an inlet opening in fluid flow communication with the source element, and an outlet opening that provides fluid flow communication with the exterior surface of a plant when the apparatus is installed on a plant.

A portion of said wall structure of the reservoir can be designed to contact the exterior of the plant, and includes sealing means that seal the wall structure on the exterior of the plant for preventing escape of non-aqueous gas phase material from the reservoir.

The invention also provides a method for delivering one or more materials to a plant comprising: locating near the exterior of a plant a source of material that forms a non-aqueous, gaseous phase to be delivered to the plant, (b) controlling the amount and the rate of release of the material from the source to a reservoir, and (c) delivering the material to the plant in a non aqueous gaseous phase from said reservoir.

Preferably, in the practice of the method, the reservoir has a peripheral wall surface that surrounds an exit opening, and the peripheral wall surface is deformable to form a relatively impermeable seal with the exterior of the plant to permit efficient delivery of the material through the opening to plants of various sizes and shapes.

Preferably, the method delivers the material to the whole plant or a substantial part of a plant including leaf, fruit, flower stem, branch, trunk, root or structures directly attached or in direct contact including soil adjacent to root, and structures in the plant not actively supporting sap flow such a voids, pith and heartwood.

Preferably delivery of the material to the plant occurs at or near atmospheric pressure, and delivery of the material occurs over a time period of at least one week.

The method permits the rate of release of material to said reservoir being controlled to deliver to the plant, over a period of at least one day, the minimum amount of material effective against harboured or persistent attacking pests thus minimizing injury to casual and short term grazers of the open plant pollen and flower structures, such as bees.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps. The use of the singular or the plural is not intended to exclude the other. It is convenient to describe the invention herein in relation to certain particularly preferred embodiments. However, the invention is applicable to a wide range of situations and it is to be appreciated that other constructions and arrangements are also considered as falling within the scope of the invention.

The source element includes a material that is an active agent on plants, such as one or more of plant growth control and augmentation agents, vitamins, hormones, pheromones, attractants, repellants, trace and macro elements and minerals, fungus, virus, bacteria, antibiotics, anti-viral agents, colour, odour enhancers or modifiers, taste enhancers or modifiers, and agents for other desired treatments, including treatments influencing plant properties such as colour, smell, rot, fungus and grazing pest resistance after harvest.

As used in the specification and claims of this patent application, the term “non-aqueous gaseous phase” means a gaseous phase that contains no liquid water and very little or no water vapor. The amount of water vapor present should be less than the level that would permit condensation of water at the ambient conditions utilized during treatment of the plant, so that the problems described herein that occur when aqueous treating agents are used can be avoided.

### BRIEF DESCRIPTION OF THE DRAWINGS

FIG. 1a shows an end view of a first embodiment of the invention.

FIG. 1b shows a schematic perspective view of this first embodiment.

FIG. 1c is a perspective view with plastic structure 1 illustrated in FIG. 1a cut away and shows a variation of the first embodiment in which the end cap members 4 do not abut the material source element 19.

FIG. 1d is a schematic end view that illustrates a sealing strip used in sealing a plastic structure designed for use with the elements of FIG. 1c.

FIG. 2a illustrates in simplified schematic form a material source element.

FIG. 2b illustrates a simplified schematic form of another embodiment of a material source element that could be configured to function as the material source element in the apparatus of FIG 1c.

FIG. 2c illustrates in simplified schematic form another embodiment of a material source element.

FIG. 3a shows a cross-section through a second embodiment of the invention before installation.

FIG. 3b shows a cross-section through the second embodiment of the invention during installation.

FIG. 3c shows a cross-section through the second embodiment of the invention after it is installed and working.

FIG. 4a is a schematic illustration of a third embodiment prepared for application to a plant.

FIG. 4b is an end view of the third embodiment prepared for application to a plant.

FIG. 4c schematically illustrates a cross section of the third embodiment installed and working on a plant.

FIG. 4d schematically illustrates an applicator for the third embodiment.

FIG. 5a schematically illustrates a fourth embodiment of the apparatus prior to installation on a plant.

FIG. 5b schematically illustrates an apparatus similar to the fourth embodiment as installed on a plant and providing treatment.

FIG. 5c schematically illustrates an applicator for the fourth embodiment.

FIG. 6a illustrates a fifth embodiment of the invention prior to installation on a plant.

FIG. 6b illustrates a fifth embodiment installed on a plant and working.

FIG. 6c illustrates an applicator for the fifth embodiment of the invention.

### DETAILED DESCRIPTION OF EMBODIMENTS OF THE INVENTION

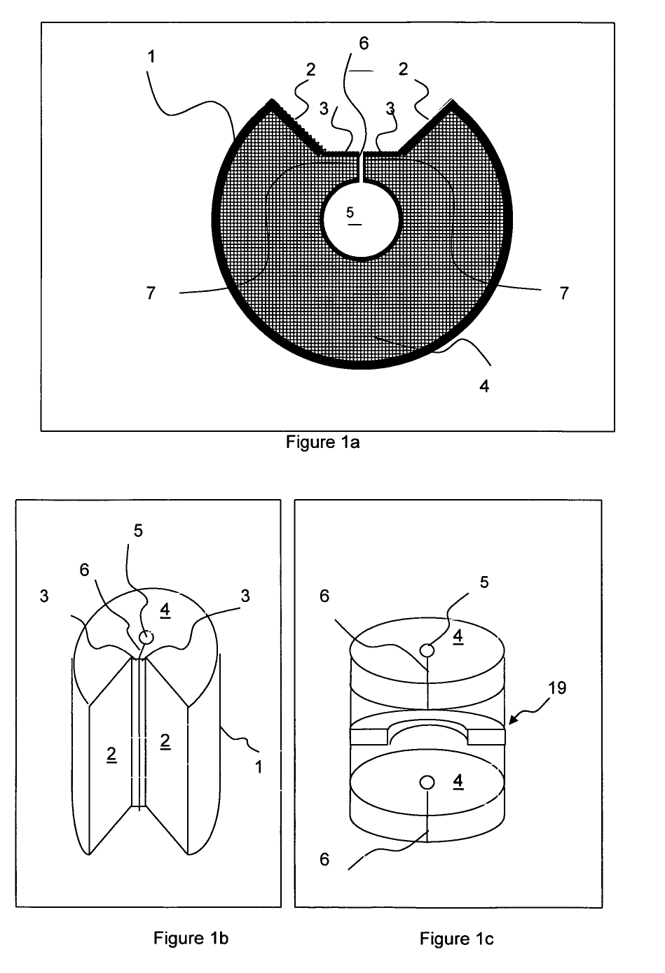

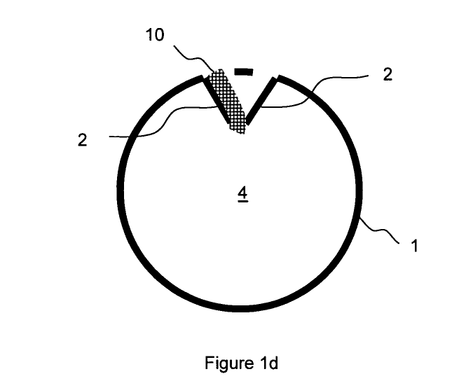

FIG. 1a shows a top or end view of a first embodiment of the invention wherein an impermeable plastic structure (1) has been formed into a tube shape and then deformed to provide a vee formed of two flat or re-entrant sections (2) and is slit to form two lips (3). A length of polyvinyl chloride pipe provides a suitable plastic structure. The plastic structure (1) can be opened by separation of the lips by applying pressure to re-entrant sections (2) when for example plastic structure (1) is forced over a stem, branch or trunk. Plastic structure (1) is made of a resilient material that will generally return to the profile it had prior to deformation. In this manner, plastic structure (1) functions as a clip that will aid in having the apparatus attach about the outer surface of a portion of the length of a plant.

The internal space (5) is capped at each end by a deformable, but impermeable cap member (4) made of a closed cell structure foam material. Cap members (4) have a slit (6) that performs two functions. The cap members (4) in conjunction with plastic structure (1), act as seals to seal the ends including the section around the trunk, branch or stem where it enters or exits. The cap members also allow entry of a range of stem branch or trunk diameters with minimal damage when installed over the plant part, while also allowing sufficient compliant expansive capacity to allow for growth without undue constriction of the plant. Cap members (4) are each illustrated as being formed of one piece, but may be formed of separate parts joined by physically abutting or by adhesive or by other means. Each cap member has lips (7) illustrated in FIG. 1a as spaced apart by slit (6), but which are placed in abutting sealing contact when the apparatus is installed on a plant by the plastic structure (1) which acts as a clip.

FIG. 1b is a perspective view of the first embodiment in the form it would be in when installed on a plant where (1) is the impermeable plastic structure that has been formed into a tube shape having a vee formed of two flat or re-entrant sections (2) and being slit. The impermeable plastic structure can be opened by separation of the lips when for example the apparatus is forced over a stem, branch or trunk or can be forced open by other means and will generally return to the profile it had prior to being opened. The compliant but impermeable closed cell foam structure cap (4) at each end, one of which is shown, has a slit (6), lips (7) and opening (5) formed to receive and seal against the plant at installation.

FIG. 1c is a perspective view of certain elements of the apparatus of FIG. 1a that are positioned within plastic structure (1) (illustrated in FIG. 1), but does not show plastic structure (1) for ease of viewing internal detail. Cap members (4) are longitudinally spaced from a material source element (19) positioned between the two closed cell foam cap members (4) and within the wall of impermeable plastic structure (1) (not shown in FIG. 1c).

FIG. 1d illustrates an adhesive backed foam sealing strip (10) having a resilient closed cell structure that is attached by the adhesive along the length of one of the flat re-entrant sections (2). Foam sealing strip (10) seals plastic structure (1) along its length, and is needed to seal a structure such as schematically illustrated in FIG. 1c in which the end cap members (4) do not abut source element (19). A second foam sealing strip (not illustrated) can be attached to the other re-entrant section (2) if desired.

For the purpose of controlling insects in or closely associated with a plant, the apparatus may include a pre-formed material element (19) containing a suitable active agent. An example of a suitable active agent an insecticide 2,2-Dichloraethenyl dimethyl phosphate also known as Dichlorvos. The Dichlorvos is uniformly distributed in a matrix of suitable controlled porosity material such as plastic. The Dichlorvos also acts as a plasticizer during forming of the plastic matrix. The matrix structure provides controlled release of the Dichlorvos and is sectioned and installed in said pockets in member (19) so that sufficient clearance is provided for enlargement of the said trunk or stem over the intended period of application of the apparatus. The invention is in no way limited to the use of this material, being applicable to any ultimately non-aqueous presentation of active material to the plant through the permeable reservoir.

The complete apparatus containing the active material element is effectively sealed against outflow of said active material vapours other than by way of the plant epidermis interface by the plastic structure (1) and compliant foam sealing provided by end cap members (4) and sealing strip (10) as illustrated in FIG. 1d.

Any number of secondary packaging materials and seals can be used externally of the apparatus for such purposes as packaging, delivery and afixing.

The apparatus is installed by forcing open the plastic structure to enable the plant to penetrate the slits in the plastic structure and the end caps and be encased along the length of the apparatus. The compliant foam can be deformed to provide sufficient capacity for expansion as the plant stem grows and so accommodates stem diameter changes without undue impediment. Ultimately plant growth may open the slit by itself, or with assistance, to terminate treatment.

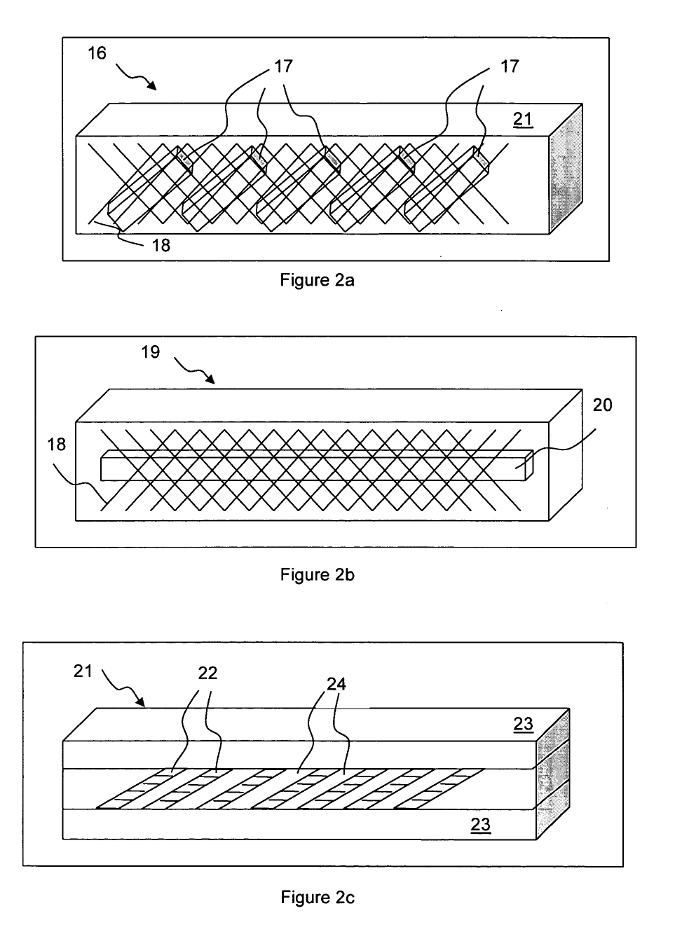

Any shed bark or other material of the plant remains contained within the reservoir during the time of treatment that may span one or more seasons. The formed seal about the plant remains relatively intact. Some leakage of active material can be accommodated by adjusting the parameters of surface area, concentration and diffusion rate for the active source material and the reservoir. The apparatus shown in FIGS. 1a, 1b, 1c and 1d contains the active material source element and provides the boundary of the reservoir for treatment materials and agents, details of which are shown in FIG. 2. For treatment of a branch, trunk or stem 4 mm in diameter for example, the plastic structure (1) could be 25 mm in outer diameter and extend for 25 mm axially along the site. This 25 mm length provides a semicircular reservoir including a section of solid matrix material permeated with treatment material and agents 4 mm by 4 mm and extending circumferentially from one flat to the other being in matrix form and emitting gaseous phase treatment of a material such as DDVP (Dichlorvos). The space between the plastic matrix and the plant forms the reservoir. The ends of this reservoir are the barriers formed by the end caps (4).

The outer ends of the apparatus can be so shaped as to avoid intrusion of any environmental materials such as water by virtue of making the ends convex, thus encouraging flow away from the site.

The matrix material may occupy the entire distance between the compliant foam end seals but does not impinge on the void at the center and so does not interfere with the plant stem or branch. The void provides a reservoir allowing non-aqueous based gaseous to diffuse into the portion of the plant stem or trunk that is positioned to pass through the void.

FIGS. 2a, 2b and 2c show arrangements for controlling surface area available for emission of the source material and also the means of controlling the area of epidermis exposed to the reservoir. These arrangements provide a means to control dosage rate in this embodiment. Another means of controlling dosage rate is the amount and the concentration of the source material.

As variations of the embodiments of FIGS. 1a, 1b and 1c and FIGS. 2a, 2b and 2c, the plastic structure (1) can be selected from High Impact Polystyrene, PVC, polycarbonate with appropriate colour and labelling as desired. The compliant foam material can be closed cell structure neoprene or nitrile foam and the open cell structure material can be urethane foam or woven cellulose fabric for example, though selection is not restricted to these materials. Variations in such apparatus would be made, each intended for a range of growth size plant leaves, stems, branches, trunks or roots. The apparatus can be placed on any available leaves, stems, branches, trunks or roots, the internal transport mechanisms of the plant then allowing for delivery throughout the plant.

The apparatus as described can be tested using a suitable test plant such as Monterey pine or blue-gum of approximately 300 mm overall height. After 2 days of installation in summer, reaching day temperatures of 28 degrees Celsius and under adequate sunlight and soil moisture, concentrations of active Dichlorvos material are present throughout the plant and in the soil adjacent to the root structures:

The following results are indicative of the achieved delivery concentrations for this embodiment, being subject of course to the actual test conditions:

Foliar mass ratio of active agent greater than 1 per million (ppm) by dry mass ratio. Trunk mass ratio above application site greater than 2 ppm by dry mass ratio.

Trunk mass ratio below application site of greater than 3 ppm by dry mass ratio, being higher than above the point of installation of the invention due to the limited time from initial application to sampling and the preferential plant sap activity of the summer growing season.

Soil adjacent to root material of greater than 1 ppm by dry mass ratio taking into account the impermeable nature of soil particles and the interstice nature of the matrix. The sampling protocol used requires immediately cold preservation including pulverisation and measurement according to NATA certification for soil mass ratio Dichlorvos, said material being a liquid with significant varporisation at typical room temperatures.

The presence of these concentrations of the active anti-cholinesterase material Dichlorvos over an extended period of time will kill all manner of insects exposed to it by action on the central nervous system while having no known adverse effect on the plant. This concentration level is achieved throughout the plant and including in the soil adjacent to the root structures, with minimum use of the material and with minimum chemical wastage and delivery outside the plant.

FIGS. 2a, 2b, and 2c show three alternative arrangements of an active material source element for use within a plastic structure (1) such as shown in FIG. 1a. The source elements are illustrated in rectangular form for clarity, but it should be understood that for use in the plastic structure (1) of FIG. 1c the material source elements would take a semi-circular form as shown as in FIG. 1c.

FIG. 2a shows an active material source element generally (16) shown as a generally rectangular block (21) of impermeable resiliently compliant closed cell foam. The block (21) of closed cell foam contains (a) the active material and any desired delivery agents (17) in one or more pockets formed in block (21). The material source element (16) may optionally be provided with a reservoir-forming spacer structure (18). Spacer structure (18) can be a thin layer of fabric gauze that functions to hold the active material and any desired delivery agent in the pockets and to permit passage of the active material and any desired delivery agents into the reservoir. Spacer structure (18) can be attached to the block (21) by various means, such as an adhesive. FIG. 2a illustrates five separate pockets within the impermeable compliant material of source element (16) with each pocket containing a volume of active material delivery agent, or a combination of active material and delivery agent. Alternatively, the spacer structure (18) could be used to hold a strip of source material (20) on a side of the source member, as illustrated in FIG. 2b.

The impermeable foam of source element (16) is of a suitable material, such as a closed foam cell structure, that offers high resistance to passage of the active diffusive materials. The source element serves to both retain and to control the exposed surface area of the active materials thus affecting release rate. The source element (16) may be extended vertically as illustrated in FIG. 2a to also form the end seals of the apparatus in which case there is no need for cap members (4) illustrated in FIG. 1c.

FIG. 2b shows a material source element generally (19) comprising a closed cell impermeable foam. A single continuous volume of source matrix material (20) is provided in the pocket. The source matrix material (20) is partially enclosed by closed cell impermeable material that forms the source element (19). The pocket in the material source element (19) and the source material (20) may extend around the circumference of the plastic structure shown in FIG. 1 from the back of one flat section 2 as illustrated in FIG. 1, to the other flat section 2. The compliant impermeable foam material of material source element (19) can be used to form the end seals in an embodiment having a top view as illustrated in FIG 1a. This foam material also forms part of the reservoir in this embodiment. A reservoir-forming boundary spacer layer (18) is provided.

FIG. 2c shows another embodiment of a material source element generally (21). In this embodiment, closed cell impermeable material layers (23) enclose a sandwich structure of alternate layers of impermeable, resiliently compliant foam (24) and permeable open cell structure foam (22) that allows the source material to be released from the open cell structure and pass from it. The open cell permeable layer (24) may also form part or all of the reservoir, allowing free passage of non-aqueous gaseous material to the plant.

Spacing material (18) is positioned between the plant and the material source and can be formed of open cell structure foam material or a fabric guaze. The material used as a retaining spacing material is selected for compliant physical nature, and degree of permeability. Many variations in retaining spacing materials are possible.

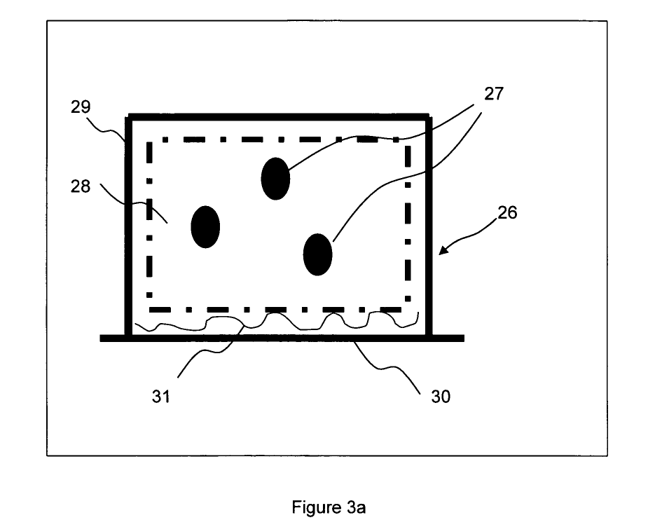

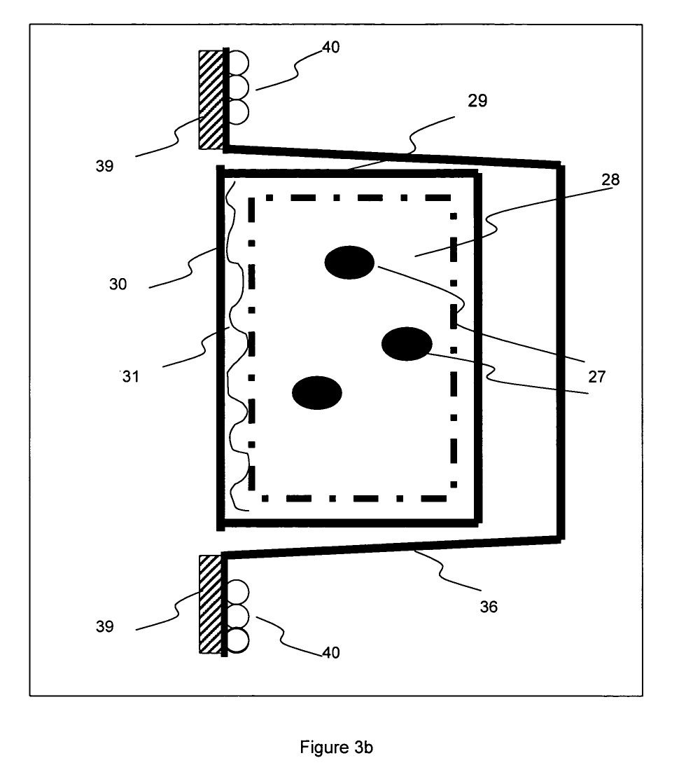

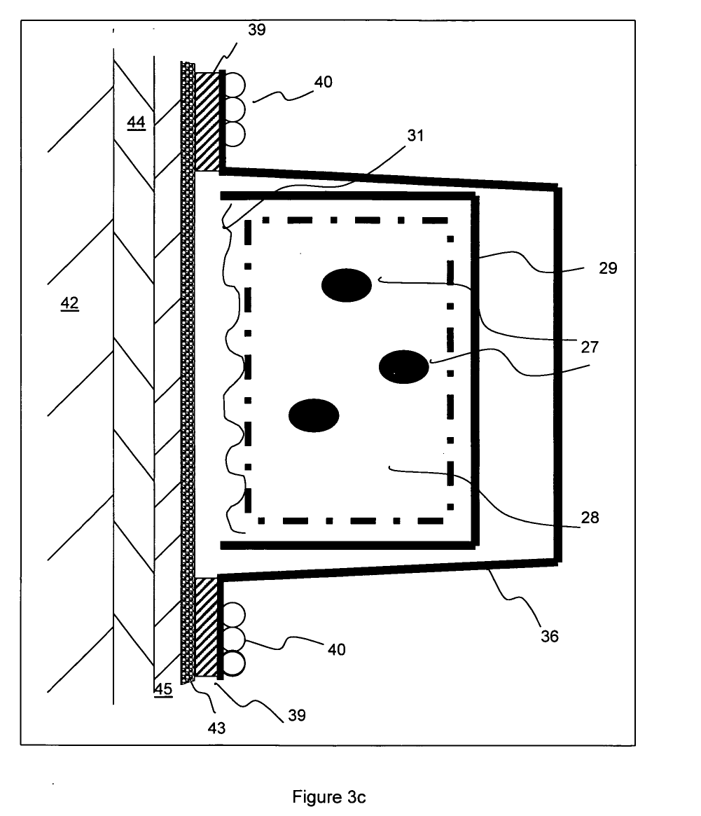

FIG. 3a is a cross-section of a second embodiment of the apparatus prior to commencing installation on a plant. The active material (27) and any delivery agents (28) are enclosed in a source element that initially functions as a container and comprises an impermeable barrier wall member (29) illustrated as having generally rectangular walls, and a removable reservoir barrier means (30). As illustrated in FIG. 3a, the removable barrier means (30) is selected to be an impermeable sheet member that is adhered to the walls of barrier wall member (29) to form a relatively impermeable seal. The adhesive used is selected to be releasable so that barrier means (30) can be removed, or partially removed, from the impermeable barrier wall member (29) just prior to use of the apparatus. The apparatus of FIG. 3 is illustrated as having a rectangular cross-sectional shape, but the exterior shape can be varied.

The structure shown in FIG. 3a represents a complete impermeable boundary to the release of active material and delivery agents, and so alternatively represents a shipping or storage container that prevents the loss of material during shipping, storage and handling prior to installation and use on a plant.

FIG. 3b is a cross-section of an embodiment of the apparatus that incorporates the apparatus of FIG. 3a and is ready to be placed in situ to provide systemic treatment of a plant. Active material (27) and delivery agents (28) are located within a source element that comprises an impermeable container formed by wall member (29) and removable barrier means (30), with the position of the removable barrier means (30) being variable to permit adjusting the area available for flow of gaseous phase material from member (29). Alternatively, barrier means (30) can be perforated, or can comprise two layers, with one layer being perforated. The apparatus of FIG. 3a is positioned in an exterior cover (36) formed of an impermeable material. Exterior cover (36) is sealed and attached to the plant by an impermeable compressible strip (39) of closed cell foam. Optionally an expanding tension providing clamp (40) is provided to force the compressible strip (39) into an impermeable sealing relationship with the plant exterior.

When the removable barrier means (30) is partially or fully removed, the active material and delivery agents will be able to begin diffusing out from the aperture formed by removal of barrier means 30, and into the reservoir and hence ultimately to the plant in a controlled manner.

Spacing material (31) is permeable and can optionally be a membrane providing for controlled permeability of a non-aqueous gas phase through the membrane. Such a membrane provides another means for controlled release of a non-aqueous gas phase from a material source when removable barrier means (30) have been removed.

FIG. 3c shows the apparatus of FIG. 3b installed on and treating a plant. The removable barrier means (30) illustrated in FIG. 2 has been removed. By this means, the active material (27) and any delivery agents (28) are able to treat the plant according to the invention, while being restricted in escape away from the plant by the impermeable membrane of the container (36). FIG. 3c also shows bark structure (43), sap transport layers (44) and (45) and the pith (42) of the plant. The apparatus of FIG. 3c may be designed to partially or completely encircle a branch, stem, limb, trunk, or other part of the plant.

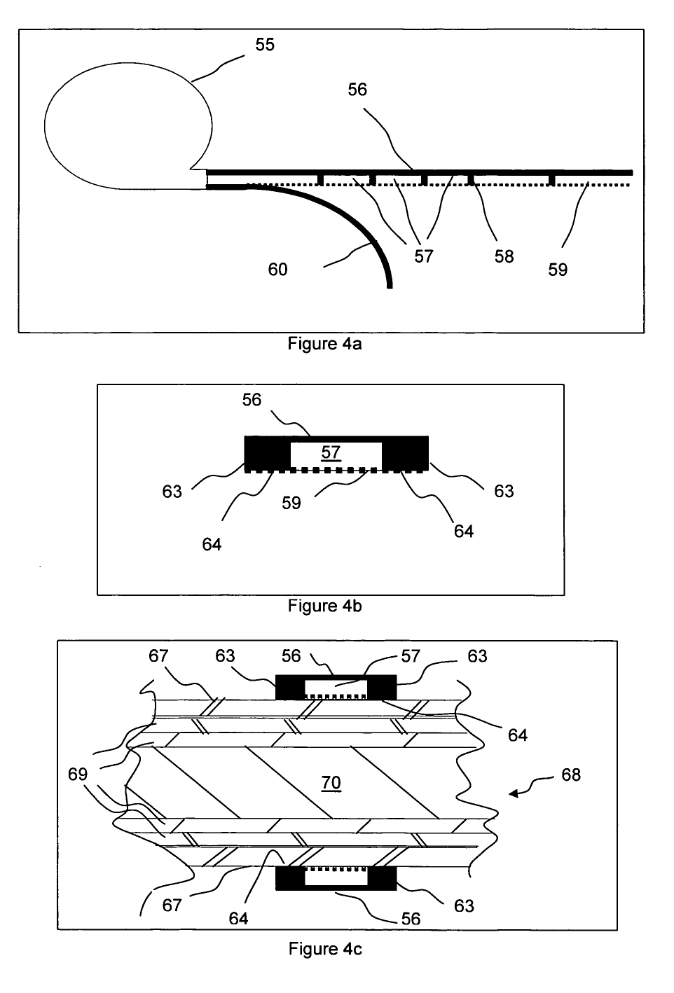

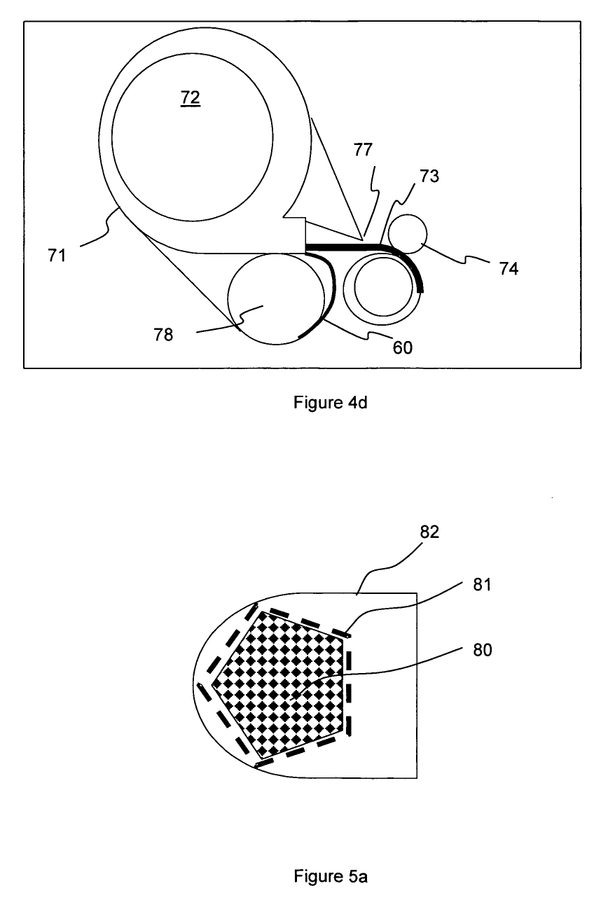

FIG. 4a is a schematic illustration, partially in cut-away cross-section of a third embodiment of the invention wherein multiple volumes (57) of the active material and delivery agents are contained by an impervious backing strip (56), a removable cover or shipping strip (60) that functions as a removable and impervious barrier, and separators (58). A spacing material (59) that forms a porous boundary of a reservoir is also included beneath the removable cover strip (60). The apparatus is formed into a roll that is schematically illustrated as (55). FIG. 4a shows a portion of the cover strip (60) partially removed in preparation for installation on a plant. Not illustrated in FIG. 4a are a pair of spaced closed cell foam strips illustrated in FIG. 4b. Foam strips (63) extend downwardly from strip (56) as illustrated in FIG. 4b.

FIG. 4b shows a cross-section of an end view of the apparatus of FIG. 4a where the cover strip (60) (shown in FIG. 4a) has been removed in preparation for installation of the apparatus on a plant. The source material and deliver agents (57) are contained by the impervious backing strip (56), and two impervious closed cell structure foam strips (63) which include surface adhesive material at the areas (64) where the strips contact a plant, and are also physically retained by the porous boundary formed by spacing strip (59). Cover strip (60) is preferably treated with a release agent to permit easy removal of the cover strip from the rest of the apparatus. FIG. 4b illustrates a foam backing strip (56), but the backing strip could be of other materials, and foam strips (63) could be adhered thereto.

FIG. 4c shows the third embodiment installed in-situ on a plant generally (68) and providing treatment. The apparatus depicted in FIG. 4a has had the cover strip (60) removed, and the apparatus has been placed on or around a plant comprising the bark (67), sap transport layers (69) and pith or heartwood (70). Adhesive located at (64) on the impervious foam strips (63) holds the apparatus in place on the plant for long term delivery of treatment. Alternatively, other attachments means can be used to hold the apparatus in place.

FIG. 4d is a schematic illustration of a mechanism for installation of the third embodiment on a plant. A dispenser (71) is provided for a roll (72) of apparatus such as illustrated in FIG. 4c that allows a measured length of the apparatus to be dispensed. The mechanism includes a means (78) of removing and optionally collecting the removable barrier means (60). Strip (73) having the end structure illustrated in FIG. 4b is dispensed from roll (72). The plant (75) receives the apparatus strip (73) under pressure of a roller (74). When the desired amount of the apparatus has been dispensed and applied to the plant, the apparatus can be cut by the knife structure (77) and is ready for application. The apparatus of FIG. 4d is constructed and operates in a manner very similar to certain devices for dispensing tape for packaging operations.

The apparatus of FIG. 4b includes a separate spacer (59) of suitable material which is so structured as to physically separate the active diffusive material of the materials from direct contact with the dermis of the plant to be treated yet allows free passage of the vapours and gasses and thus forms a portion of the reservoir according to the invention.

The embodiment of FIGS. 4a and 4b is intended for rapid easy installation and flexible adjustment of dosage. The use of multiple smaller dosages in isolated compartments allows the tape to be cut anywhere and not destroy the delivery mechanism by forming an overall leak of the material.

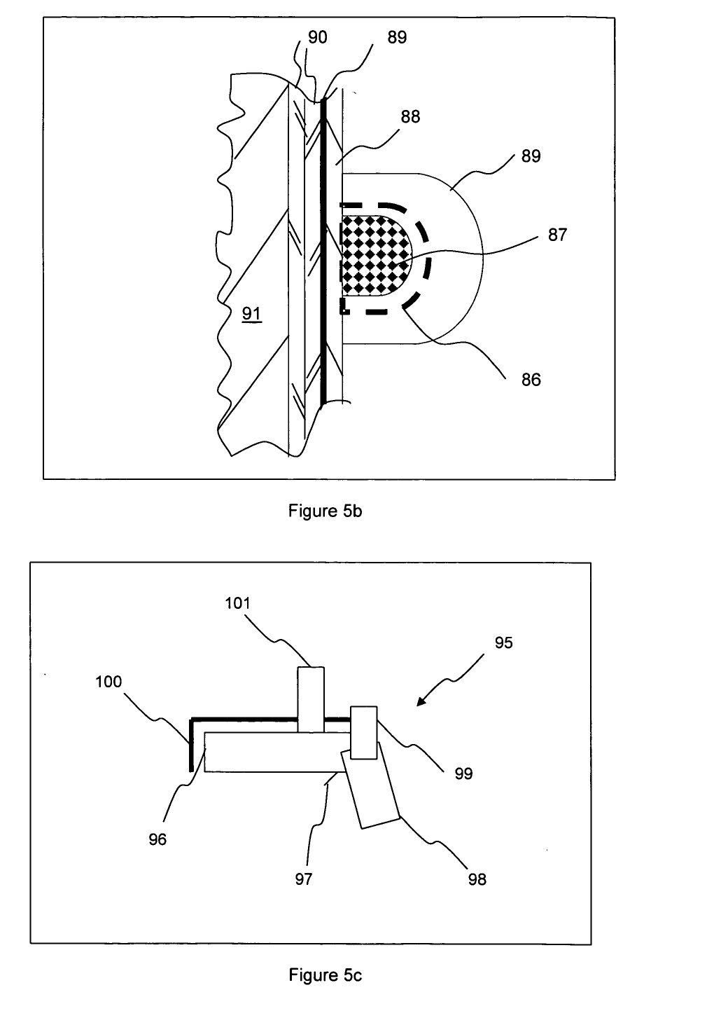

In a fourth embodiment shown in FIGS. 5a, 5b and 5c the material source element (80) includes an active agent that diffuses in a suitable moulded permeable plastic matrix material thus allowing timed release of material by diffusion, said plastic matrix material also at least partially acting as a spacer during use forming the reservoir.

FIG. 5a shows a cross section of a fourth embodiment of the apparatus. Material source element (80) is surrounded by the boundary of a spacer (81) that forms the porous reservoir. Material source element 80 is completely surrounded by containment means (82) made of a plastic impermeable material having the properties of flow under high strain and also adhesion. Containment means (82) is shaped as shown so that when projected at or otherwise forced onto the surface of a plant, containment means (82) will deform adjacent the plant and an opening or openings will be formed that expose at least some areas of the reservoir formed by containment means (82) to the plant.

FIG. 5a shows a combination of material source element (80), spacer (81) and containment means (82). The combination provides a least some initial resistance to shear stresses or force while the containment means provides some adhesive properties. The combination is made into a form referred to as a sabot and is intended to be either pushed or projected at low velocity onto the plant by a large bore gun or other apparatus and in so doing bringing the active material forward to begin delivery through the reservoir.

FIG. 5b shows a cross section of an apparatus similar to the fourth embodiment installed on the surface and providing treatment to a plant. The apparatus has been applied to the epidermis (89) of the plant over any surface features including bark (88). The epidermis (89) covers the sap flow regions (90) of the plant (91). The containment means (85) has deformed on impact and includes openings adjacent the plant that permit the porous reservoir (86) to allow material and delivery agents to be delivered to the plant by allowing the gaseous vapour to begin penetrating the epidermis to the sap transport layers in the plant. The concentration of active material in the reservoir is replenished by the source element (87). The deformation of the plastic material having adhesive properties also provides fixing of the apparatus to the plant and sealing of the periphery of the apparatus on the plant, either solely or with other aiding arrangements, but without need to physically penetrate the dermis of the plant.

FIG. 5c shows a device for installation of the fourth embodiment wherein a low velocity gun generally (95) having large bore (96) and propelling means (98) such as air under pressure, is used to propel the apparatus to the surface of the plant when a trigger (97) is operated.

An interlocking means (100) is provided to ensure correct operation, and is capable of disabling the propelling means firing mechanism (99). The propelling means 98 and barrel are so designed as to impart the required low velocity to the apparatus to appropriately deform the impermeable material on impact with the plant without damage to the plant epidermis. By this means the apparatus is propelled to the plant, adheres and commences treatment at once. A hopper, magazine or other replenishing supply of apparatus (101) is optionally provided. The combination of the plant requirements and the dose provided by each apparatus governs the number of applications of this embodiment of the apparatus per plant, being at least one.

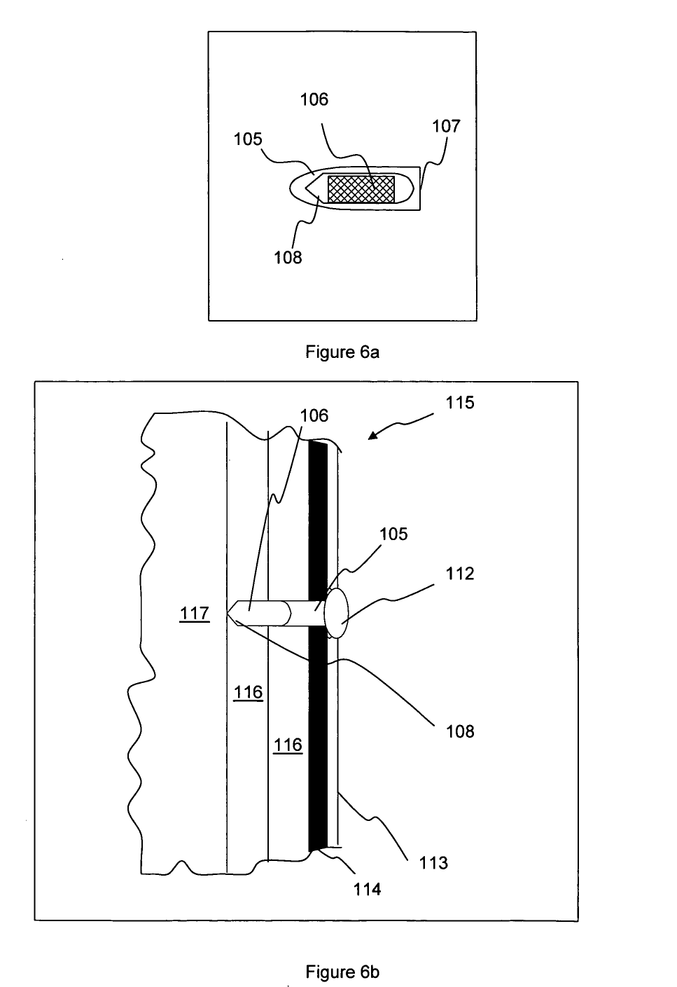

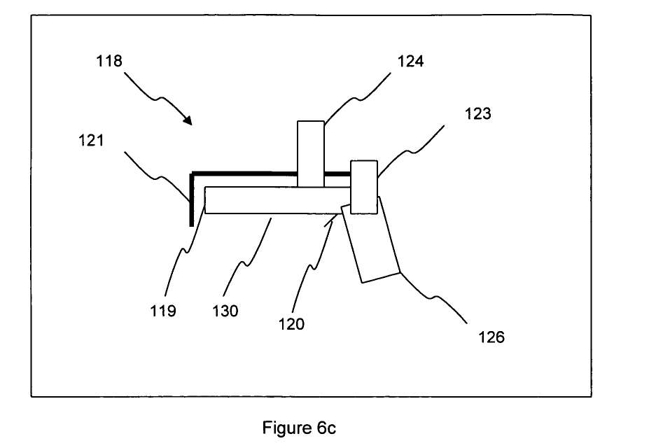

FIG. 6a shows a cross-section of a fifth embodiment wherein a material source element (108) includes suitable porous matrix material. Both source element (108) and a porous reservoir boundary layer that encloses material the source element and is schematically illustrated at (106) are wholly enclosed in a shaped impermeable plastic barrier (105). The rear (107) of the apparatus may be flush finished as shown or may provide means of accessing and replenishing the porous matrix with source material and delivery agent as required after installation on a plant.

FIG. 6b shows a schematic cross section of the apparatus in-situ and providing treatment to a plant generally (115) wherein the plastic impermeable layer (105) has deformed and been peeled back from the source element (108) and reservoir boundary (106) during penetration of the bark (113) and dermis (114), with excess material shown forming a head that somewhat deforms the soft external bark material. The sap transport layers (116) and pith layer of the plant (115) are also shown. Sufficient plastic material has been deformed to provide a seal of the penetration point (112). The apparatus of FIG. 6b can be provided with an accessible rear protrusion for replenishment of material.

FIG. 6c is a diagram of an apparatus for installation of the fifth embodiment on a plant. A gun generally (118) having a barrel (130) with a suitable bore (119) and propelling means (126) is used to propel the apparatus to and partially through the surface of a plant when a trigger (120) is operated. An interlocking means (121) is provided to ensure correct operation, said interlock capable of disabling the propelling means firing mechanism (123).

The propelling means and barrel are designed to impart the required velocity to the apparatus to appropriately deform the impermeable layer (105) on impact with the plant. By this means an apparatus is propelled to or partially into the plant, affixes and commences treatment at once. A hopper, magazine or other replenishing supply of apparatus (124) is optionally provided. The combination of the plant requirements and the dose provided by each apparatus governs the number of applications of apparatus per plant which is always at least one.

The invention provides a delivery apparatus and a method for non-aqueous gaseous phase delivery of a wide range of materials with or without facilitating agents. In its broader embodiments, the invention is not dependent on the precise nature of the material, other than it permit delivery by a non-aqueous gaseous phase. The disclosed embodiments identify a known representative material able to be traced and detected and also having suitable properties of some commercial value in the treatment of plants. The invention is not at all limited to the use of the stated source material, being suited to a variety of materials that are ultimately non-aqueous in presentation to the plant and capable of gaseous diffusion.

Attachment means for attaching the apparatus to the plant can be a clip, patch, tape, wrap, surface impact adhering projectile or a trans-dermally penetrating spike, pin or projectile.

The apparatus can be preset to deliver both the type and the rate of treatment and scale the dosage at the point of need to account for growth rates, temperatures, transpiration, general weather conditions and the like, and can scale the delivery rate with seasons and application time as required for maximum effectiveness.

The means of controlling the rate and or amount of release can provide for controlling the concentration, rate of diffusive emission, surface area, temperature and total amount of material, emergence or the material from an impermeable barrier, and be accomplished by a variety of gating and valving structures.

Access to the permeable reservoir can be controlled by removable barrier means such as a valve structure, controlled permeability, a rupturable membrane, or an impermeable membrane that can be peeled away from the wall of the reservoir.

Preferably, the part of the permeable reservoir that presents the material to the plant in a non-aqueous gaseous phase has surface adhesive, mechanical attachment or other physical retaining properties including clipping and gripping structures.

Preferably, the permeable reservoir is sealed or is self sealing when not in contact with the plant.

Certain embodiments of the invention enable new treatment regimes including delivery of agents normally susceptible to degradation by air or soil contact or ultraviolet light. Enabled treatment regimes include but are not limited to grazing insect repellents, pollination and fruit growth control agents, fungus, bacteria and virus control agents, growth control factors for example for selective pruning, provision of colour, odour and flavour subsititutes and enhancers and marsupial and other grazing pest discouragers.

The nature and rate of release of the source material to the reservoir, the presentation of gaseous phase to the plant and the effective transfer into the plant may be controlled by a variety of suitable methods, for example the methods previously disclosed.

Preferably, the installation and operation of the apparatus does not damage the plant dermis.

The amount and rate and nature of the delivered material or substance can be controlled so that the concentrations of the material or substance in the plant are sufficient to be effective for the purpose intended by the concentrations in extremities of the plant that are more open in nature such as flowers and associated parts such as pollen are sufficiently low to be non-injurious to casual grazers including bees.

The apparatus can be made tamper resistant when in place.

The apparatus visibly indicates its presence on a plant and can be labelled to state the nature of treatment.

In some embodiments, the disclosed method and apparatus can present scaled amounts of material to the plant over an extended and controlled period of time by way of continuous renewal and control of the concentration of the source of material and its rate of release, the concentration of material in the reservoir and of the surface area of the plant epidermis exposed to this permeable reservoir.

In one embodiment, the apparatus and method replenish the material of the reservoir according to concentration difference between source material and the reservoir. However, any suitable means may be used to replenish the reservoir. For example, it may be replenished by chemical reaction (for example by dissolution of a solid into a liquid phase by virtue of changes in concentration of the substance in the liquid phase). Equally, other methods are suitable, for example, mechanical, electro-chemical, etc. The invention presents non-aqueous vapour to the plant according to the concentration difference between the reservoir and the plant thus enabling transfer through the dermis and into the plant.

Desirably seals are formed to restrict flow away from the plant treatment site that allow for plant growth while retaining a sealing action. The seals can be formed by compliant closed cell structures and materials that can include combinations of more than one means such as those formed in situ at time of application by chemical means such as foam silicone or urethane.

It is believed that the transfer of material into the plant utilizes gaseous diffusion processes based on concentration gradients. The concentration gradients may be provided over extended periods of time. Gaseous diffusion does not tend to provide either short or long term damage to the plant. Normal plant processes such as shedding bark can continue within the plant and are taken advantage of by the invention.

An advantage of the invention is that it does not present an aqueous based interface to the plant at the application site and so does not cause, provide or sustain any undesirable secondary problems such as bacterial, viral or fungal presence or primary or secondary insects and the like, and the plant does not react to the presence at the site of treatment as would be the case if it were water based, thus enabling long term treatments spanning timeframes from weeks to years.

It is believed that after the gaseous non-aqueous material diffuses into the plant that the internal processes of the plant may then transport the material throughout the plant structure. Thus, transport may be effected to various parts of the plant including trunk, pith, branch, stem, leaf, fruit, flower and root and including tree tops and root tips and to soil immediately adjacent. In some embodiments, this is controlled in part by the presented concentrations from the invention and the transport activity of the plant which in turn is linked to the size of the plant, the nature of its environment including temperature, rainfall and the like and the season. By this means a feature is the ability to control dosage to meet demand over extended periods of time and variations in season and growth.

In some embodiments, the amount of material delivered to the plant can be controlled by various factors such as the surface area of the reservoir in communication with the plant, the concentration and surface area of the reservoir material and the use of deliver facilitating agents. These in turn can be linked to environmental factors such as temperature and light.

Consistent delivery to the plant from a reservoir can occur over a wide range of variations in the interface condition between the plant and the reservoir including the presence of varying layers and shedding of bark at the interface or about the epidermis for example, or as would occur with changes in girth at the interface as could occur with some plants over extended treatment periods.

Various embodiments may treat all types of plant including monocotyledon and dicotyledon plant types and non-circulatory regions including heartwood, pith, damaged tissue, partially or fully enveloped dead tissue, voids, soil immediately adjacent to the root structures and the like within or closely associated with the plant.

The reservoir can be designed to present material to the plant while excluding undesired external environmental factors such as oxygen, soil, organisms and mircoorganisms, virus, bacteria, fungus, water and other physical agents and ambient light including of an ultraviolet nature and thereby enable the delivery of the widest range of materials including those sensitive to moisture, oxygen and ultraviolet light for example.

The material source or the reservoir, or both, can be designed to commence material delivery controlled by one or more factors. Such may for example include physical action including removal of a cover or barrier, opening of a valve, temperature change or trigger, rupture due to a freeze-thaw cycle, detection of incident light in the presence of transpiration or plant vapours at each treatment site or remote telemetry means. Commencement of material delivery may be designed to be reversible or non-reversible according to the intended application, thus enabling application of the apparatus at times convenient to the user but with treatment occurring at the most appropriate time and for the desired interval for the individual plant.

The source of material or the reservoir or both can be designed to respond to temperature over a controlled period of time after onset and so control or track this seasonal factor in varying the vapour or gaseous concentration. This allows compensation for growing cycles linked to temperature, light and conserves active essence or material at the same time, and enables effective treatment over the growing season.

Delivery of material can be controlled to provide for increasing, decreasing or constant material delivery by use of structures controlling release from the source of material or alternatively from the reservoir over extended periods of time measured in weeks using mechanisms such as chemical breakdown of barriers based on temperature and time, with materials emerging from an impermeable material over time by forces including gravity and floatation.

Control of the end of the treatment cycle can be effected by factors including chemical breakdown or formation of barriers based on temperature and time, impermeable envelopment, physical or chemical combination or breakdown, valving structures and the like. Independent control of onset, sustain and decay of treatment for each material can be by control of delivery.

The apparatus can be loaded with materials for a particular plant species or treatment and for a particular size plant, taking into account desired rates and concentrations, local seasonal variations and other factors as desired.

Effective treatment to the plant can be provided independently of the nature of the sap flow within the plant, so including treatment of monocotyledon and dicotyledon plant types and non-circulatory regions including voids, heartwood, pith, damaged tissue, partially or fully enveloped dead tissue and the like within or closely associated with the plant.

Effective treatment of the plant can be independent of the nature of the epidermis and the materials thereon including existing bark or bark being produced during treatment. The apparatus and method allow for surface irregularities, while forming an effective seal to ensure adequate delivery to the plant.

The apparatus can be self contained and relatively safe to use requiring low operator skill for its use, minimising the possibility of operator chemical contamination through factors including no need for chemical mixing in the field, design of the invention packaging and containment and controlled release and low level dosing keeping concentrations low and avoiding unwanted chemical trespass.

Convenience of apparatus application can be provided in the form of a tape with removable sealing strip and comprises an applicator apparatus for use at the time of installation, thus speeding application and allowing adjustment of amount on a plant-by-plant basis.

The apparatus illustrated in FIGS. 5a and 6a can be mounted in sabots formed of plastic or other material as is well known in the art prior to being propelled onto the plant. A suitable sabot is usually designed to separate from the apparatus shortly after exit of the apparatus from the barrel of application means.

### EXAMPLE 1

A plant delivery apparatus was made starting with a length of PVC Piping having 2 mm wall thickness. This was post-formed by heating of a region on the outside and forming into a vee structure by use of a vee shaped roller and former on the material softened by heat. This section was then cut into 23 mm long pieces and the bottom of the formed vee was slit to provide flat reentrant sections, such as illustrated as element 2 on FIG. 1d. The section so formed was then forced partially open and a strip of adhesive backed closed cell nitrile foam (10) as shown in FIG. 1d was attached so that it attached to one flat side of a flat section (2) and protruded through the slit.

The closed-cell-structure, impermeable, adhesive backed foam strip (10) is attached to at least one of the flats so that it protrudes through and thus seals the aperture under action of the clip structure closing. Pressure on the other flat reentrant section (2) can reopen the apparatus to allow entry of the plant stem branch or trunk.

A closed cell structure nitrile foam plug 9 mm thick was cut so that it was an interference conformal fit in the end of the PVC section and had a slit extending to its centre where a circular hole of 2 mm diameter was cut through. This plug was then installed in the end of the PVC section using a suitable curing adhesive for nitrile to PVC, namely a silicone polymer.

The active material selected for use in this example is 2,2-Dichlorovinyl dimethyl phosphate, also known as Dichlorvos. This active material is sold commercially in the form of a plastic matrix having about 20% by weight Dichlorvos uniformly distributed in the plastic matrix. The Dichlorvos in a plastic matrix is sold as part of a commercial product called No Pest Strip under the brand Hot Shot. The product is intended for use against insects indoors for example in garages, storage spaces and attics. Dichlorvos impairs the central nervous system of insects.

A section 38 mm long by 4 mm square of about 20% Dichlorvos uniformly distributed in a plastic matrix was cut, deformed and installed in the section against the foam plug and spanning from one flat to the other in a semicircular arc, and then a second foam plug was installed to effectively form the reservoir inside the PVC section. A strip of plastic material was used to ensure that the slit and foam plug slits aligned and were not obstructed by adhesive application. This was placed in the slit while the plugs were installed, and was removed after curing of adhesive. The invention so made was then labelled and stored in an airtight bag ready for application and use. It was intended for use on branch or stem diameters from 2 mm up to 10 mm diameter above which the growth of the branch would interfere with the material matrix and force the clip open thus stopping the treatment. This example demonstrates a compact and easy to apply plant delivery apparatus.

### EXAMPLE 2

An embodiment of the invention was made as a clip from a 90 mm outside diameter 3 mm thick PVC tube section by the same means of forming and slitting the vee as described in example 1 and cutting to 75 mm lengths. The slit was sealed with conformal impermeable closed cell structure adhesive backed nitrile foam strip of total 6 mm thickness 25 mm wide and penetrating the slit adhered to the flat. The end foam plugs were made by closed cell structure nitrile foam sheet of total 25 mm thick with a slit and central 20 mm hole cut for interference fit in the PVC section and glued inside either end.

The apparatus was loaded with from one to five 25 mm square sections of 20% Dichlorvos in a plastic matrix. The square sections are mechanically retained between the two end foam sections spaced around the inside of the PVC section and held in place with impermeable foam strips forming a seal around each plastic matrix piece. The rate and duration of release of the Dichlorvos from the matrix to the reservoir was thus controlled by restriction of the exposed matrix surface area on one side. The invention was used on plants from 20 mm to 70 mm diameter trunk by clipping the apparatus around the trunk. The treatment was for aphids and was effective in completely clearing the initial infestation within 11 days on a 6 meter domestic climbing rose specimen and maintaining protection over two spring seasons without intervention being required, and without adverse effect on casual grazers such as bees.

It is understood that the invention is not restricted in any way by the preferred embodiments and examples and that a wide range of applications and treatments are possible with the apparatus and method of delivery of the apparatus.

Finally, it is understood that many other forms and embodiments are possible without departing from the ambit of the invention.

What is claimed is:

1. An apparatus for delivering one or more materials to a plant including:
a source element that comprises a material that provides a non-aqueous gaseous phase to be delivered to a plant,
a reservoir in fluid flow communication with said source element, said reservoir providing non-aqueous gaseous phase flow of said one or more materials from said reservoir to the plant.

2. The apparatus of claim 1 wherein there is further provided control means for controlling the flow of said one or more materials to the plant.

3. The apparatus of claim 1 in which the source element is spaced from and not in physical contact with the plant.

4. The apparatus of claim 1 wherein said reservoir is in fluid flow communication with the exterior of the plant and the material is delivered transdermally to the plant.

5. The apparatus of claim 3 including attachment means for attaching the apparatus to the plant.

6. The apparatus of claim 5 wherein said reservoir surrounds at least half of the circumference of the plant at the location of attachment of the apparatus on the plant.

7. The apparatus of claim 1 wherein the source element includes a material that is an active agent.

8. The apparatus of claim 7 in which the source element includes a trans-dermal delivery facilitation material.

9. The apparatus of claim 2 wherein the control means controls flow of a gas phase from said source element to said reservoir.

10. The apparatus of claim 1 including removable barrier means for preventing flow of gas phase material to the plant until the start of the desired plant treatment period.

11. The apparatus of claim 1 wherein said reservoir has peripheral walls that surround an exit opening, said peripheral walls possessing surface conformal properties to enable a relatively impermeable seal to form between the reservoir wall and the plant exterior.

12. The apparatus of claim 1 in which said reservoir contains material at or near local atmospheric pressure and delivers to the plant said material at or near local atmospheric pressure.

13. The apparatus of claim 1 in which the reservoir includes a wall structure that is substantially gas phase impermeable, and an outlet opening that provides fluid flow communication with the exterior surface of a plant when the apparatus is installed on a plant.

14. The apparatus of claim 13 in which a portion of said wall structure of said reservoir is designed to contact the exterior of the plant and includes sealing means for preventing escape of non-aqueous gas phase material from said reservoir.

15. A method for delivering one or more materials to a plant comprising:
(a) locating near the exterior of a plant a source of material that forms a non-aqueous, gaseous phase to be delivered to the plant,
(b) controlling the amount and the rate of release of the material from the source to a reservoir, and
(c) delivering the material to the plant in a non aqueous gaseous phase from said reservoir.

16. The method of claim 13 wherein the reservoir has a peripheral wall surface that surrounds an exit opening, and said peripheral wall surface is deformable to form a relatively impermeable seal with the exterior of the plant to permit efficient delivery of said material through said opening to plants of various sizes and shapes.

17. The method of claim 13 where delivery of the material is to the whole plant or a substantial part of a plant including leaf, fruit, flower stem, branch, trunk, root or structures directly attached or in direct contact including soil adjacent to root, and structures in the plant not actively supporting sap flow such a voids, pith and heartwood.

18. The method of claim 13 where delivery of the material to the plant occurs at or near atmospheric pressure.

19. The method of claim 13 where delivery of the material occurs over a time period of at least one week.

20. The method of claim 13 where the rate of release of material to said reservoir is controlled to deliver to the plant, over a period of at least one day, the minimum amount of material effective against harboured or persistent attacking pests thus minimizing injury to casual and short term grazers of the open plant pollen and flower structures, such as bees.
